(19) United States
(12) Patent Application Publication
(10) Pub. No.: US 2007/0070253 A1
(43) Pub. Date: Mar. 29, 2007

(54) Portable wireless audio-visual transmitting/receiving device

(76) Inventors: Sheng-Fu Lu, Taipei Hsien (TW); Yu-Yuan Lee, Taipei Hsien (TW)

Correspondence Address: TROXELL LAW OFFICE PLLC, Suite 1404, 5205 Leesburg Pike, Falls Church, VA, 22041, US

(21) Appl. No.: 11/236,588

(22) Filed: Sep. 28, 2005

(51) Int. Cl. H04N 5/268

(52) U.S. Cl. 348/705

(57) ABSTRACT

A portable wireless audio-visual transmitting/receiving device is designed for wirelessly receiving and showing (monitoring) audio-visual programs. The transmitting/receiving device comprises a transmitter, a receiver, and a remote control, wherein the transmitting/receiving device can be integrated into the DVD player by wireless transmission. Besides, the image-showing function of LCD monitor can be used for showing CATV programs and images/sounds captured by the wireless video camera in addition to showing the DVD such that the purposes of taking care of children, aged persons, and patients and safety monitoring can be achieved. In addition, the transmitting/receiving device can be portably carried for showing any programs anywhere, anytime as long as it is located within the effective distance.

### FIELD OF THE INVENTION

The present invention relates to a transmitting/receiving device, and more particularly to a portable wireless audio-visual transmitting/receiving device for showing programs anywhere, anytime as long as it is located within the effective distance. For instance, CATV programs and images/sounds captured by a wireless video camera can be received and shown by the transmitting/receiving device.

### BACKGROUND OF THE INVENTION

The current TV set, VCD player, DVD player have been become essential entertaining tools of life. The general family usually owns at least two TV sets. Besides, every floor, every room, and the living room may be provided with at least one TV set. If it is desired to watch CATV, VCD, or DVD by use of all the TV sets, each TV set must be connected to the CATV signal line, the VCD player, and the DVD player simultaneously. As a result, several VCD and DVD players must be purchased and a lot of CATV lines must be mounted. Accordingly, it is money consuming and makes the wiring environment complex.

### SUMMARY OF THE INVENTION

In view of the increase of cost and required space caused by providing every TV set with essential receiver for integrating TV sets, VCD players, and DVD players located on different floors with one another, the present inventor discloses a portable wireless audio-visual transmitting/receiving device, which is located within the effective distance, in accordance with his experience in the art.

First of all, by use of the transmitter of the present invention, the signals from the CATV, DVD player, VCD player, VCR, and wireless video camera can be received by the receiver mounted on the same floor or building within the effective transmission distance, and these signals can be provided for more than one TV set.

The present invention provides the following advantages, in which:

1. In addition to showing the DVD, the CATV programs and the images/sounds captured by the wireless video camera can be shown.

2. The monitor of the player can be used for showing the CATV programs and the images/sounds captured by the wireless video camera besides showing the DVD such that the purposes of taking care of children, aged persons, and patients and safety monitoring can be achieved.

3. The transmitting/receiving device of the present invention is portable for showing programs anywhere, anytime as long as it is located in the effective transmission locations such as bedroom, kitchen, yard, bathroom, upstairs/downstairs, dining room, etc.

4. By connection with the CATV signal line, the transmitting/receiving device can act as a second TV tuner for being applied to the location to where several TV sets are mounted simultaneously such that the second TV set can show TV programs without wiring.

### BRIEF DESCRIPTION OF THE DRAWINGS

FIG. 1 is an elevational view showing the structure of the present invention.

FIG. 2 is an elevational view showing the receiver of the present invention.

FIG. 3 is a block diagram showing the processes of transmitting, receiving, and controlling signals of the present invention.

FIG. 4 is a block diagram showing the connection between the transmitter and the signal lines of CATV, DVD player, VCD player, and VCR of the present invention.

### DETAILED DESCRIPTION OF THE PREFERRED EMBODIMENT

The above-mentioned features and advantages of this invention, and the manner of attaining them, will become more apparent and the invention will be better understood by reference to the following description of embodiments of the invention taken in conjunction with the drawings.

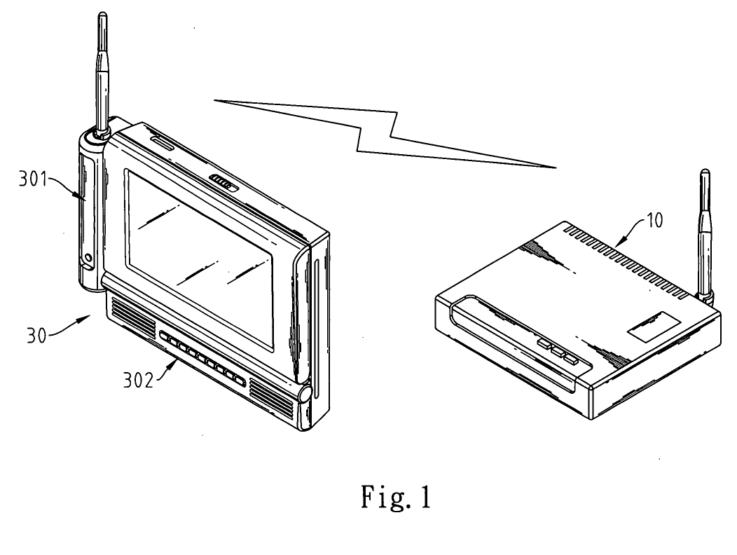

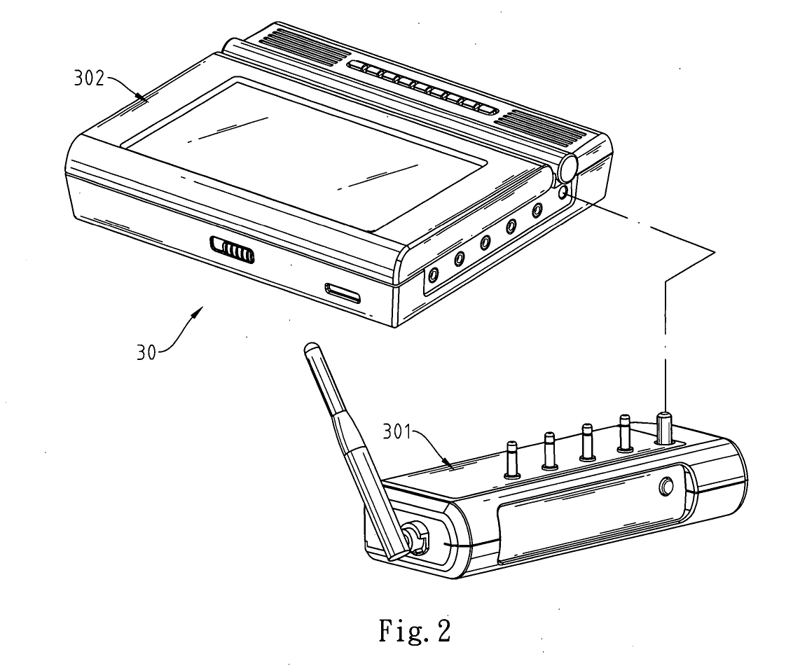

Referring to FIG. 1 and FIG. 2, the portable wireless audio-visual transmitting/receiving device of the present invention comprises a transmitter 10, a remote control 20, and a receiver 30, wherein the receiver 30 is composed of a receiving machine 301 and a player 302. The receiving machine 301 is directly inserted into the lateral of the DVD player 302 by connection terminals. As a result, the receiving machine 301 is portable. After inserting the receiving machine 301 into the lateral of the DVD player 302, the DVD player 302 can provide the receiving machine 301 with required electric power. The receiving machine 301 can receive 4 to 8 sets of wireless signals. The remote control 20 is designed for switch between these wireless signals. In addition, the receiving machine 301 can show the currently displayed channel by light.

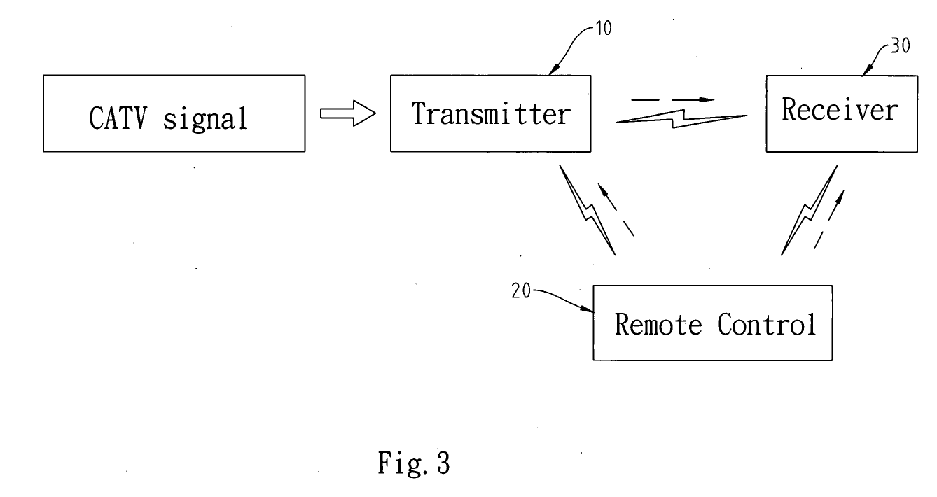

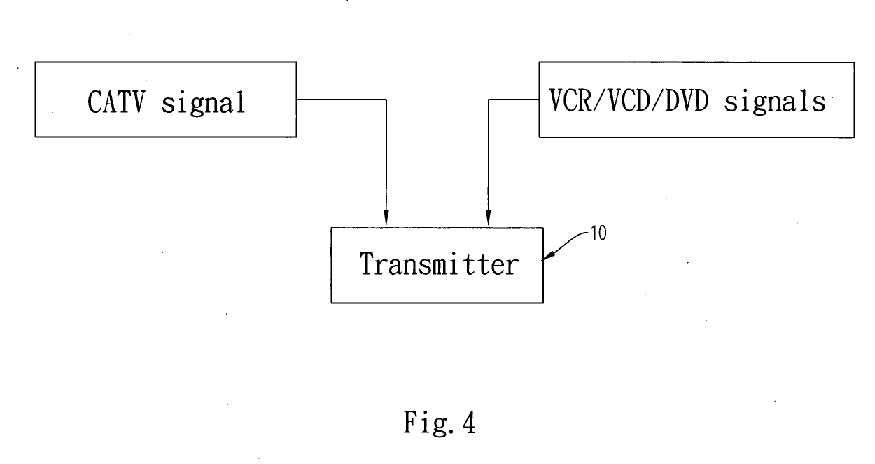

Referring further to FIG. 3 and FIG. 4, in this present invention, the signal lines of CATV, VCR, DVD player, and VCD player are connected to the transmitter 10. For instance, the CATV signal line is connected an input terminal of an splitter (not shown), wherein one output terminal of the splitter is connected to the main TV set and the other output terminal of the splitter is connected to the transmitter 10. It is worth mentioning that if there is only a single TV set, the CAVT signal line can be connected to the transmitter 10 directly without use of the splitter. In addition, the signal lines of VCR, VCD player, or DVD player can be optionally connected to A/V input terminals of the transmitter 10.

Accordingly, all signals of CATV, VCR, VCD player, and DVD player can be received by the receiver 30, and the remote control 20 is used for channel switch. In addition, the 2.4 GHz receiver 30 is enabled to receive the signals within a predetermined effective transmission range by wireless transmission such that the remote control 20 can switch the displayed channels into one another. As a result, only a single receiver 30 is required to enable several TV sets or computer monitors within the predetermined effective transmission range to show TV programs. Accordingly, the transmitting/receiving device of the present invention is portable for showing any programs anywhere, anytime as long as it is located in the effective transmission locations such as bedroom, kitchen, yard, bathroom, upstairs/downstairs, dining room, etc.

By use of the transmitter 10 of the present invention, the signals from the CATV, DVD player, VCD player, VCR, and wireless video camera can be received by the receiver 30 mounted on the same floor or building within the effective transmission distance, and these signals can be provided for more than one TV set, thereby achieving the advantages of connecting several DVD and VCD players by wireless connection and preventing waste of space. The monitor of the player can be used for showing CATV programs and images/sounds captured by the wireless video camera besides showing the DVD such that the purposes of taking care of children, aged persons, and patients and safety monitoring can be achieved.

What the invention claimed is:

1. A portable wireless audio-visual transmitting/receiving device having a receiver, a transmitter capable of wirelessly transmitting signals of a CATV, a VCR, a DVD player, a VCD player, and a wireless video camera, and a remote control for switch between channels of CATV, VCD, DVD, and monitoring, the improvement of the portable wireless audio-visual transmitting/receiving device comprising:
the transmitter being connected to an CATV signal line by an input terminal, and a plurality of signal lines of the VCR, the VCD player, or the DVD player being connected to a plurality of A/V input terminals of the transmitter; and
the receiver being composed of a receiving machine and a player, the receiving machine being inserted into the lateral of the player, the receiving machine being able to receive 4 to 8 sets of wireless signals, the remote control being designed for switch among said wireless signals, the wireless signals transmitted from the transmitter being wirelessly received by the receiver such that the purposes of taking care of children, aged persons, and patients and safety monitoring can be achieved.
